(19) United States
(12) Patent Application Publication
(10) Pub. No.: US 2003/0175473 A1
(43) Pub. Date: Sep. 18, 2003

(54) Surgical table pad with fluid waste channel

(76) Inventors: Timothy Gillum, Oklahoma City, OK (US); Kenneth Deese, Oklahoma City, OK (US); Charles Dieter, Beaverton, OR (US)

Correspondence Address: BRADLEY M GANZ, PC, P O BOX 10105, PORTLAND, OR, 97296

(21) Appl. No.: 10/388,705

(22) Filed: Mar. 13, 2003

Related U.S. Application Data
(60) Provisional application No. 60/364,412, filed on Mar. 14, 2002.

(51) Int. Cl. B32B 3/26

(52) U.S. Cl. 428/71; 428/130; 428/131; 428/182; 428/304.4; 428/913

(57) ABSTRACT

The present invention provides a surgical table pad of simple design that insulates a patient from a surgical table to help maintain temperature and prevent rapid loss of body heat that may cause complications for the patient. The surgical table pad includes a drainage channel to allow body fluids resulting from the surgery to flow into the drainage channel. The surgical table pad includes a series of air passages in communication with each other and with a vent opening to exhaust air within the surgical table pad to ensure more body contact between the patient and the foam pads. The surgical table pad further includes handle-receiving openings along opposed sides so that, when handles are inserted into the openings, the patient can simply be lifted from the operating table while remaining on the surgical table pad.

This invention claims the benefit of co-pending U.S. Provisional Application No. 60/364,412 entitled “Surgical Table Pad With Fluid Waste Channel”, filed Mar. 14, 2002, the entire disclosure of which is hereby incorporated by reference as if set forth in its entirety for all purposes.

### TECHNICAL FIELD

This invention is directed to surgical equipment and, more particularly, to a surgical table pad for use during a medical operation procedure.

### BACKGROUND OF THE INVENTION

There are a variety of known surgical tables for supporting a patient such as a human or animal during an operation. In veterinary hospitals and clinics surgical tables often include a support surface that is made of metallic material such as, for example, stainless steel. The support surface may be flat. However, it is common for veterinary surgical tables to include a support surface formed with sidewalls that are inclined toward the center of the surgical table to help support the animal during the surgical procedure. The support surface may be a unitary stationary surface or may include a bifurcated surface with means to move opposed surfaces from a substantially flat position to a position in which the opposed surfaces slant or tilt toward the center of the table. It is common for surgical tables to have a central slot or channel that collects and facilitates disposal of body fluids resulting from surgery.

One problem with surgical tables is that the metal support surface may cause rapid loss of body temperature of the patient. Such rapid loss of body temperature may cause the patient to go into shock and/or cause other complications which can be especially problematic during long operational procedures.

There have been attempts to overcome this problem. There are known surgical mats and pads that are temperature controlled in order to prevent loss of body temperature. For example, one known device uses a fluid filled pad with a heater and pump to circulate heated fluid, typically water, through the pad. This device does reduce loss of body temperature. However, it requires a heating device to heat the fluid and a pump to pump the fluid through the pad. This extra equipment takes up space and increases costs. Additionally, such pads are subject to damage and leakage of the heated fluid should a surgeon accidentally nick or cut the pad with a surgical knife or other sharp instrument. If the pad is punctured or cut, the pad must then be replaced which is a costly expense.

Another device that reduces loss of body temperature can be seen in U.S. Pat. No. 6,318,372, which discloses a vacuum-activated veterinary surgical positioning system. The device includes a flat bag filled with elastically deformable beads. A valve is provided for connection with a vacuum source to withdraw air so that the bag conforms to the body of the patient. However, among other things, this device includes a complicated valve and requires a vacuum source in order to be effective.

One problem with all prior art surgical pads and mats is that there is no means to collect and dispose of body fluids resulting from the surgical procedure.

Another problem with prior art surgical pads is that the patient must be lifted from the pad to a recovery area. This adds stress to the patient and could cause medical complications.

Yet another problem with prior art surgical pads is that they are complicated in design and costly to produce and/or replace.

These and other problems in the prior art are overcome by the present invention.

### SUMMARY OF THE INVENTION

The present invention provides a surgical table pad of simple design that insulates a patient from a surgical table to help maintain temperature and prevent rapid loss of body heat that may cause complications for the patient. The surgical table pad includes opposed temperature-sensitive foam pads enclosed within a pad cover with the outer edges of the pad cover being sealed. The pad cover is further sealed between the opposed pads to form a drainage channel to allow body fluids resulting from the surgery to flow into the drainage channel. The drainage channel includes openings at each end of the surgical pad to allow body fluids to flow out of the drainage channel for disposal. The pad cover is preferably made of a clear material so that should any cuts in the pad cover occur the foam pads would become stained providing an indication of damage and/or contaminated.

The surgical table pad includes a series of air passages located along inner and outer edges of the surgical table pad. The air passages are in communication with each other and with a vent opening to exhaust air within the surgical table pad to ensure more body contact between the patient and the foam pads.

The surgical table pad further includes handle-receiving openings along opposed sides so that, when handles are inserted into the openings, the patient can simply be lifted from the operating table while remaining on the surgical table pad.

The surgical table pad is also capable of being folded for convenient storage.

It is an object of the invention to provide a surgical table pad that reduces loss of body temperature and allows for longer operating procedures.

Another object of the invention is to provide a surgical table pad that includes means to collect and dispose of body fluids resulting from a surgical procedure.

Still another aspect of the invention is to provide a surgical table pad that allows the patient to be lifted from the surgical table while remaining on the surgical table pad.

These and other objects of the present invention will be apparent to persons skilled in the art from the following detailed description.

### DESCRIPTION OF THE DRAWINGS

FIG. 1 is a top view of the surgical pad of the present invention.

FIG. 2 is an end view of the surgical pad as shown in FIG. 1.

### DETAILED DESCRIPTION

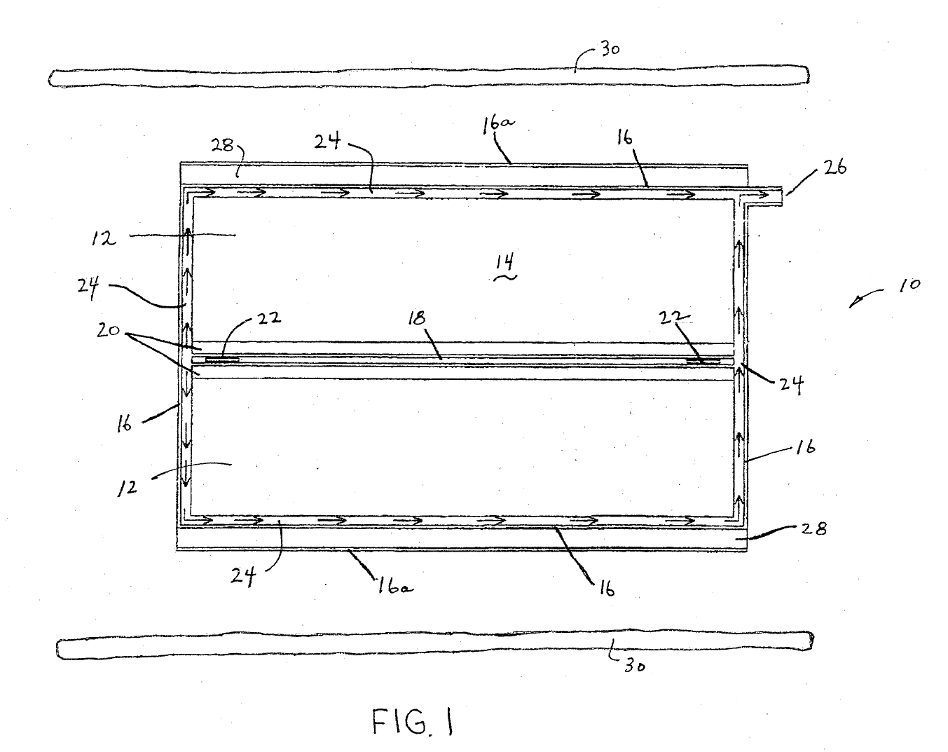

As seen in FIG. 1, surgical pad 10 comprises two separate pads 12 enclosed within a pliable and smooth cover 14 made of any suitable material. For example, one suitable cover material is polyurethane. Pads 12 are made of a soft cushion material such as, for example, foam. The foam may be of any type capable of supporting a surgical patient. Preferably, pads 12 are made of a 5 lb. density, 10 lb. compression, temperature sensitive visco-elastic foam. Pads 12 are temperature sensitive so that they become more pliable as the temperature increases. When a patient is lying on surgical pad 10 the patient's body heat is transferred to pads 12 in the contact areas between the patient and pads 12 and reflected back to the patient. Pads 12 absorb the patient's body heat and as the temperature of pads 12 increases they become more pliant and conform to the patient's body. This provides a greater surface area contact between the patient and pads 12 resulting in greater retention of body heat. Portions of pads 12 not in contact with the patient remain more firm in the surrounding areas adding support to keep the patient positioned properly. Pads 12 have a heat capacity and properties that help prevent excessive loss of body temperature of the patient. Pads 12 insulate the patient so that the patient's body temperature remains stable for an extended period of time.

Cover 14 may be any type of polyurethane film that is impermeable to air and moisture and is easy to clean and sterilize with any type of cleaning solution. One example of a preferred type is a 20 mil film that is highly elastic and extremely tough yet soft and supple to touch. Cover 14 has a smooth finish and is clear so that pads 12 remain visible. Cover 14 is preferably clear so that damage from nicks, punctures, or cuts from surgical instruments can be readily detected. If cover 14 is damaged in such manner pads 12 become stained with body or medical fluids and one can readily detect the damage. Preferably, pads 12 are of a color such that damage and/or contamination can be readily detected. Seals 16 are formed on the outer edges of the cover 14 preferably by a radio frequency (RF) weld to be resistant to air and moisture and to protect pads 12 from becoming soiled during surgery and from cleaning products.

Pads 12 are spaced apart and cover 14 is sealed or RF welded between pads 12 to form a drainage channel 18 to collect body fluids resulting from the surgery. Additionally, each pad 12 has a beveled inner edge 20 that forms sidewalls for drainage channel 18. Drainage channel 18 includes an opening 22 at each end of surgical pad 10 to allow any body fluids to drain out for disposal. Additionally, drainage channel 18 provides a location for the spine of the patient during the surgical procedure for stabilization.

In order to prevent air pockets from forming in surgical pad 10 a series of air passages 24 are located throughout surgical pad 10. Preferably, air passages 24 are located along the outer perimeter of the surgical pad 10. Passages 24 are in communication with each other and open to the atmosphere through a vent opening 26. When a patient is placed on surgical pad 10, air located within passages 24 is exhausted through vent opening 26 so that the patient's body more fully contacts pads 12 allowing pads 12 to better conform to the patient's body. Vent opening 26 is located so that no fluids will reach pads 12. Vent opening 26 must be kept unobstructed during use to allow any air in passages 24 to exhaust. When it is desired to clean and/or disinfect surgical pad 10 a clamp (not shown) closes off vent opening 26.

Surgical pad 10 further includes handle-receiving openings 28 located along opposed sides of surgical pad 10 to receive elongated handles 30. As seen in FIG. 1, handles 30 have a length that is longer than surgical pad 10 to extend past ends of surgical pad 10 to be grasped so that the patient can be moved from the surgical table to a recovery area while remaining on surgical pad 10. Openings 28 are formed by sealing cover 14 at 16a along the length of surgical pad 10.

Surgical pad 10 may be assembled using conventional techniques, although the collection of steps may define novel methods. For example, before assembly, cover 14 may be in the form of a single sheet. The sheet is then folded over on itself and two of the outer side edges are RF welded forming a top cover and a bottom cover leaving one open outer side edge. The visco-elastic pads 12 are inserted between the top and bottom covers through the open side so that pads 12 are spaced apart leaving an open area between them. The top and bottom cover are then compressed together at the open area and RF welded to form drainage channel 18 between pads 12. Openings 22 are then cut in drainage channel 18 at both ends of surgical pad 10 to allow drainage of any fluids for disposal. The cover material is RF welded in a manner to create air passages that run along the outer perimeter of each pad. Vent opening 26 is left open to atmosphere.

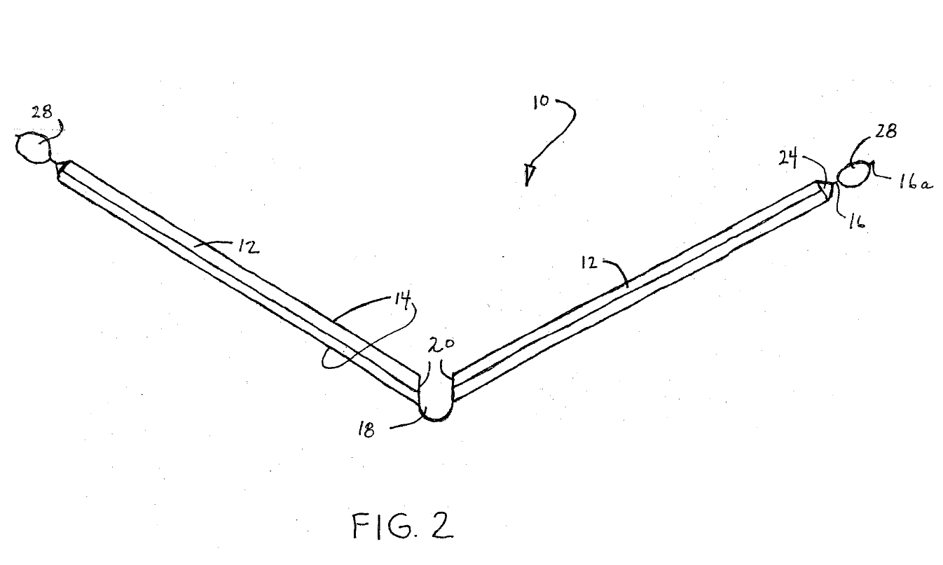

In use, surgical pad 10 is placed on a surgical table (not shown) most of which have opposed sides that slant toward the center of the table so that surgical pad 10 is in the position seen most clearly in FIG. 2. This position not only helps to stabilize the patient but also facilitates the flow of fluid into drainage channel 18.

The foregoing embodiments and features are for illustrative purposes and are not intended to be limiting, persons skilled in the art being capable of appreciating other embodiments from the scope and spirit of the foregoing teachings.

We claim:

1. A surgical table pad for supporting a patient on a surgical table, comprising:
opposed elongated foam pads enclosed within a cover material forming a support surface for a surgical patient, each pad having an inner elongated side and an outer elongated side, the pads being positioned with their respective inner elongated sides substantially parallel and spaced apart,
a drainage channel formed between the spaced inner elongated sides of the pads to collect body and medical fluids resulting from a surgical procedure, and
openings in the drainage channel to allow fluids collected in the drainage channel to flow out for disposal.

2. The surgical table pad of claim 1, wherein the inner elongated sides of each pad are beveled and slope toward the drainage channel.

3. The surgical table pad of claim 1, wherein the openings are formed at opposed ends of the surgical pad.

4. The surgical table pad of claim 1, further comprising plural air passages located within the surgical table pad, wherein the air passages are in communication with the atmosphere.

5. The surgical table pad of claim 4, wherein the air passages are in communication with the atmosphere through a vent opening.

6. The surgical table pad of claim 1, further comprising a handle-receiving structure located along each outer elongated side of the surgical table pad.

7. The surgical table pad of claim 6, wherein each handle-receiving structure is formed by the cover material.

8. The surgical table pad of claim 7, wherein each handle-receiving structure is formed by an elongated opening in the cover material.

9. The surgical table pad of claim 8, further comprising elongated handles to be received in the elongated openings so that a surgical patient can be moved to a recovery area.

10. A method of making a surgical table pad, comprising the steps of;
providing a single sheet of cover material,
folding the sheet over on itself forming a top cover and a bottom cover with outer side edges, and
sealing two of the outer side edges leaving one outer side edge open.

11. The method of claim 10, further comprising the step of inserting opposed elongated foam pads through the open outer side edge so that the pads are between the top and bottom covers.

12. The method of claim 11, further comprising the step of positioning the pads in a spaced apart manner leaving an open area between them.

13. The method of claim 12, further comprising the step of sealing the top and bottom covers together at the open area between the pads to form drainage channel.

14. The method of claim 13, further comprising the step of forming openings in drainage channel.

15. The method of claim 10, further comprising the step of sealing the top and bottom covers in a manner to create air passages that run along an outer perimeter of each pad.
